(19) United States
(12) Patent Application Publication
(10) Pub. No.: US 2008/0204221 A1
(43) Pub. Date: Aug. 28, 2008

(54) ENVIRONMENTAL MONITORING IN ACCORDANCE WITH A TEST CONFIGURATION HIERARCHY

(75) Inventors: David F. Elderkin, Wynnewood, PA (US); Michael S. Goetter, Mount Laurel, NJ (US); Anatoliy Chudnovskiy, Chalfont, PA (US); Joseph Mozelesky, Eagleville, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Moda Technology Partners, Inc.

(21) Appl. No.: 11/679,616

(22) Filed: Feb. 27, 2007

(51) Int. Cl. G08B 23/00

(52) U.S. Cl. 340/517

(57) ABSTRACT

Techniques for monitoring an environment in accordance with a test configuration hierarchy are disclosed herein. The test configuration hierarchy may include at least a leaf level and a root level. The leaf level of the test configuration hierarchy may correspond to a test, while the root level of the test configuration hierarchy may correspond to a location at which a sample is collected in accordance with the test. The test configuration hierarchy may also include a number of intermediate levels corresponding to various areas or sub-divisions within a location.

### BACKGROUND OF THE INVENTION

Environmental monitoring is a process that involves testing of different areas, entities and/or individuals within an environment to ensure that they are in compliance with various standards. The environmental monitoring standards may correspond to appropriate levels of “clean” or sanitary conditions that are required to be maintained within an environment. Environmental monitoring standards may, for example, be set by a government agency such as the United States Food and Drug Administration (FDA) in accordance with government regulations. As another example, environmental monitoring standards may be set by a private corporation or other organization. Environmental monitoring may be performed as part of and in compliance with the standard operating procedures (SOP's) of an agency, corporation, or other organization. Each product or group of products that are produced within an environment may have its own corresponding set of environmental monitoring requirements. Environmental monitoring tests may involve, for example, sampling of air, surfaces, water or personnel in a location such as a lab, plant, or other facility. Environmental monitoring tests may be performed by any number of supervisors, technicians, reviewers or other individuals.

Because environmental monitoring standards may involve appropriate levels of “clean” or sanitary conditions within an environment, it may desirable to avoid transporting certain equipment into the testing environment that could cause or spread contamination of the environment. Accordingly, many conventional environmental monitoring systems avoid employing computers as part of the collection and processing of test samples. Computers typically operate in combination with devices such as fans and printers which may spread contamination in a clean environment. Thus, many conventional environmental monitoring systems still rely on traditional pen and paper based collection of samples. Unfortunately, however, these pen and paper based systems are limited because they are very susceptible to human error in the recording of test conditions and results. Additionally, it is difficult to view, search, organize, and filter testing data in paper form, thereby making the evaluation and analysis of pen and paper test results a difficult, expensive and time consuming process. Often, a problem will have spread to several batches or iterations of a product before it can be detected and effectively pinpointed using pen and paper based test results.

Another drawback associated with many conventional environmental monitoring systems is that they provide little, if any, support for organizing and/or structuring various aspects of testing processes. This lack of organizational support may cause substantial difficulties throughout different phases of environmental monitoring such as, for example, assigning tasks to various technicians, allowing the technicians to view or otherwise be made aware of their assigned tasks, and reviewing and analyzing test results. These difficulties may be amplified as the size of the organization or facilities or the number of individuals involved in the environmental monitoring process is increased. In particular, with only limited knowledge of the structural organization or layout of a testing facility, it may be difficult to assign tasks to technicians in an efficient manner. For example, it would likely be inefficient to assign 20 tasks in the same room to 20 different technicians, or to assign multiple tasks to a single technician that must be performed at far away locations. Additionally with only limited knowledge of the structural organization or layout of a facility, it may be difficult for a technician to move about a facility and perform his assigned tasks in an efficient manner. Furthermore, when analyzing results, it may be difficult to pinpoint an exact source or effected area for a contamination or problem within the facility.

Thus, there is a need for techniques that enable environmental monitoring to be performed in a more efficient manner.

### SUMMARY OF THE INVENTION

Techniques for monitoring an environment in accordance with a test configuration hierarchy are disclosed herein. The test configuration hierarchy may include at least a leaf level and a root level. The leaf level of the test configuration hierarchy may correspond to a test, while the root level of the test configuration hierarchy may correspond to a location at which a sample is collected in accordance with the test. The test configuration hierarchy may also include a number of intermediate levels corresponding to various areas or sub-divisions within a location. For example, a first (e.g., root) level of the test configuration hierarchy may correspond to a facility, a second level of the test configuration hierarchy may correspond to rooms and/or water systems within a facility, a third level of the test configuration hierarchy may correspond to sites within a room or water system, and a fourth (e.g., leaf) level of the test configuration hierarchy may correspond to a test that is performed at a site.

Other features and advantages of the invention may become apparent from the following detailed description of the invention and accompanying drawings.

### BRIEF DESCRIPTION OF THE DRAWINGS

The foregoing summary, as well as the following detailed description of the invention, is better understood when read in conjunction with the appended drawings. For the purpose of illustrating the invention, there is shown in the drawings exemplary embodiments of various aspects of the invention; however, the invention is not limited to the specific methods and instrumentalities disclosed. In the drawings:

FIG. 1 is a block diagram representing an exemplary environmental monitoring workflow;

FIG. 2 is a block diagram representing an exemplary test configuration hierarchy;

FIG. 3 is an illustration of an exemplary facility screen;

FIG. 4 is an illustration of an exemplary room screen;

FIG. 5 is an illustration of an exemplary site screen;

FIG. 6 is an illustration of an exemplary test screen;

FIG. 7 is an illustration of an exemplary room layout;

FIG. 8 is an illustration of an exemplary general pool filter screen;

FIG. 9 is an illustration of an exemplary general pool results screen;

FIG. 10 is an illustration of an exemplary user listing screen;

FIG. 11 is an illustration of an exemplary current workspace filter screen;

FIG. 12 is an illustration of an exemplary current workspace results screen;

FIG. 13 is an illustration of an exemplary sampling screen;

FIG. 14 is an illustration of an exemplary print label screen;

FIG. 15 is an illustration of an exemplary results entry screen;

FIG. 16 is an illustration of an exemplary electronic signature screen;

FIG. 17 depicts an exemplary test result graph;

FIG. 18 depicts an exemplary action and alert chart;

FIG. 19 depicts an exemplary minimum and maximum value chart;

FIG. 20 is an illustration of an exemplary environmental monitoring (“EM”) system; and

FIG. 21 is a block diagram representing an exemplary generic computing system suitable for use in a system in accordance with the present invention.

### DETAILED DESCRIPTION OF ILLUSTRATIVE EMBODIMENTS

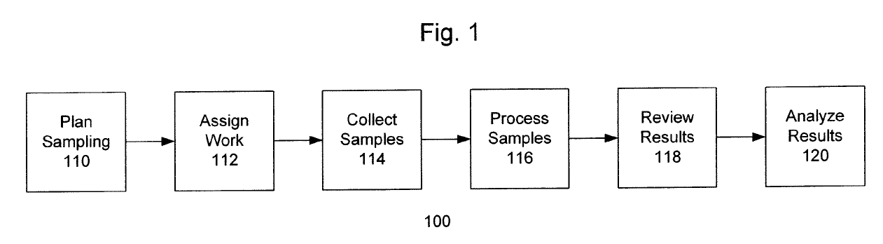

Systems and methods for environmental monitoring in accordance with a test configuration hierarchy are described below with reference to FIGS. 1-21. Those skilled in the art will readily appreciate that the description given herein with respect to those figures is for explanatory purposes only and is not intended in any way to limit the scope of the invention. Throughout the description, like reference numerals will refer to like elements in the respective figures.

A block diagram representing an exemplary environmental monitoring workflow 100 is shown in FIG. 1. During plan sampling stage 110, one or more testing facilities can be configured, and a number of tests can be defined and scheduled. During assign work stage 112, a pool of worked can be viewed, the pool of work can be filtered into different subsets according to various criteria, and subsets of the pool of work can be assigned to individual users. During collect samples stage 114, individual users can view their corresponding assignment lists and collect samples in accordance with their corresponding assignment lists. The collected samples are then processed during process samples stage 116. During review results stage 118, test results may be entered, reviewed according to various criteria, and, if appropriate, approved. During analyze results stage 120, results may be filtered according to various criteria and viewed, explored and analyzed using various analysis tools. Each of the stages 110-120 included in workflow 100 will be described in detail below.

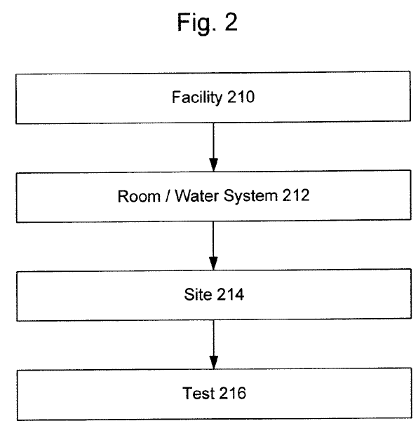

During plan sampling stage 100, one or more testing facilities can be configured, and a number of tests can be defined and scheduled. Each testing facility may be configured according to a test configuration hierarchy. An exemplary test configuration hierarchy 200 is shown in FIG. 2. The first (root) level node of test configuration hierarchy 200 is facility node 210. The second level node of test configuration hierarchy 200 is room/water system node 212. The third level node of test configuration hierarchy 200 is test site node 214. The fourth (leaf) level node of test configuration hierarchy 200 is test instance node 216. Accordingly, each facility may include one or more rooms or water systems. Each room or water system may, in turn, include one or more sites. Each site may, in turn, have one or more associated tests that are performed at the site.

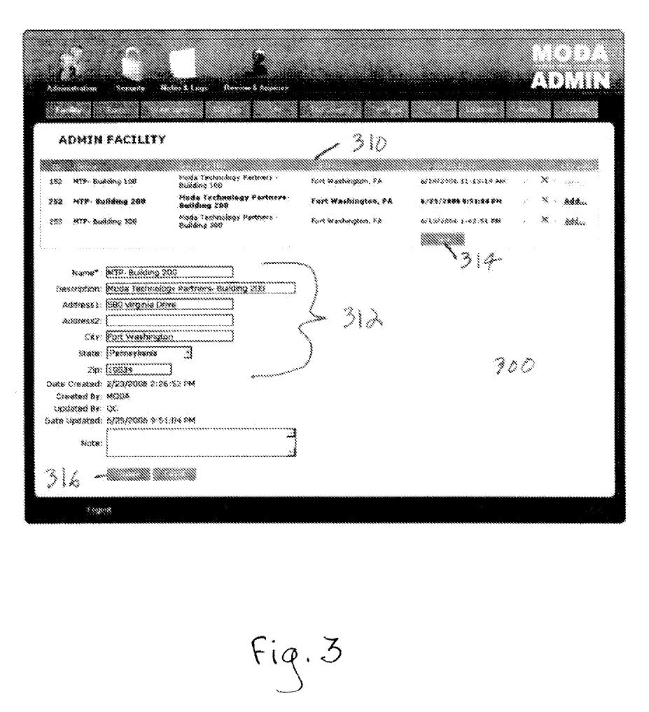

An exemplary facility screen 300 for creating, editing, viewing and removing facilities is shown in FIG. 3. Facility screen 300 includes a facility listing 310 that lists each currently defined facility. As shown, there are three currently defined facilities that are included in the facility listing 310. Any one of the currently defined facilities may be edited by selecting the facility within the facility listing 310. The corresponding row for the currently selected facility in the facility listing 310 is shown in bold face type. As shown, “MTP-Building 200” is the currently selected facility in the facility listing 310. Underneath the facility listing 310, a number of input fields 312 are displayed which enable a user to edit various information associated with the currently selected facility. These user input fields 312 include, Name, Description, Address 1, Address 2, City, State and Zip. The user input fields 312 depicted in facility screen 300 are included by way of example and not limitation, and any other additional or alternative input fields may be provided in accordance with the present invention. After the currently selected facility has been satisfactorily edited, the new edited information may be submitted by touching down on “Update” button 316. Additionally, a “New” button 314 is displayed at the bottom of the facility listing 310. Touching down on the “New” button 314 enables a new facility to be created and defined using the appropriate input fields 312. After being created and defined, the new facility may also be display in the facility listing 310. Touching down on the “X” button displayed at the right end of each row in the facility listing 310 enables the corresponding facility to be removed from the facility listing 310.

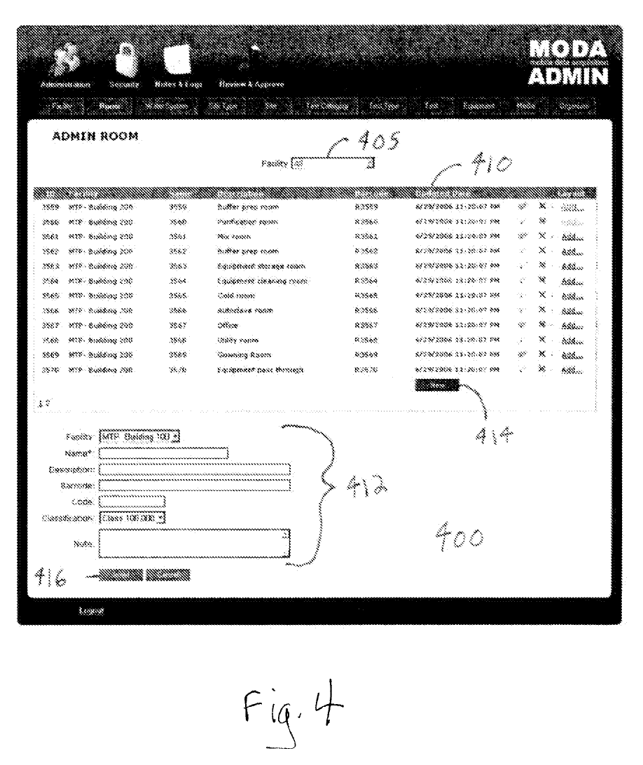

Returning to FIG. 2, as depicted in node 212, the second level of the test configuration hierarchy 200 corresponds to rooms and/or water systems. For environmental monitoring tests, facilities are sub-divided into rooms, while, for water tests, facilities are sub-divided into water systems. An exemplary room screen 400 for creating, editing, viewing and removing rooms is shown in FIG. 4. Room screen 400 includes a facility drop down menu 405 that enables a currently defined facility to be selected in which to create, edit, view or remove rooms. Room screen 400 also includes a room listing 410 that lists each room that is currently defined within the facility selected in facility drop down menu 405. The “All” option is currently selected in facility drop down menu 405, which causes all rooms in all currently defined facilities to be displayed in room listing 410. Additionally, a “New” button 414 is displayed at the bottom of the room listing 410. Touching down on the “New” button 414 enables a new room to be created and defined using the appropriate input fields 412. After the new room has been satisfactorily defined, the new room may be entered into the system by touching down on “Insert” button 416. Any of the currently defined rooms may also be edited by selecting the room within the room listing 410. When a room is selected in the room listing 410, the room's corresponding row in room listing 410 is shown in bold face type. Selecting a room in room listing 410 will cause the current information corresponding to the room to be displayed in user input fields 412, at which point such information may be edited and then resubmitted. Touching down the “X” button displayed at the right end of each row in the room listing 410 enables the corresponding facility to be removed from the room listing 410.

As mentioned above, in addition to being sub-divided into one or more rooms for environmental monitoring tests, a facility may also be sub-divided into one or more water systems for water tests. Water systems may be created, edited, viewed and removed by users by way of a separate water system screen. Such a water system screen will not be described in detail, but it may include a water system listing, corresponding user input fields, and any other additional or alternative displays, fields or information.

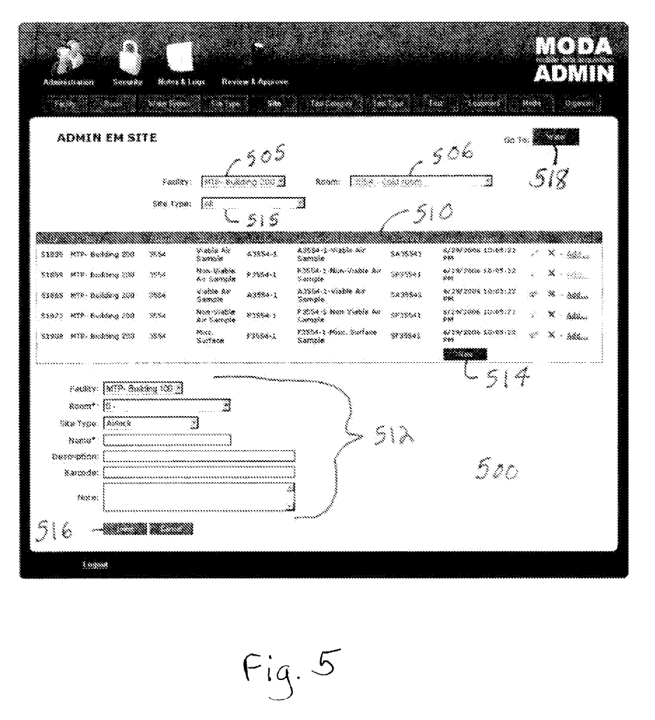

Returning again to FIG. 2, as depicted in node 214, the third level of the test configuration hierarchy 200 corresponds to sites. An exemplary site screen 500 for creating, editing, viewing and removing sites is shown in FIG. 5. Site screen 500 includes a facility drop down menu 505 that enables a currently defined facility to be selected in which to create, edit, or view sites. Site screen 500 also includes a room drop down menu 506 that further sub-divides the facility selected in the facility drop down menu 505. The rooms that are made available in room drop down menu 506 will depend on the facility that is selected in facility drop down menu 505. Site screen 500 also includes a “Go To” button 518 that enables site screen 500 to be switched between environmental monitoring mode and water mode. Currently, site screen 500 is in environmental monitoring mode, meaning that it is configured for environmental monitoring. In particular, in environmental monitoring mode, site screen 500 includes a room selection menu (e.g., room drop down menu 506) and the “Water” value is displayed in “Go To” button 518. Touching down on the “Water” value displayed in “Go To” button 518 may cause site screen 500 to be switched to water mode, in which room drop down menu 506 may be replaced with a water system drop down menu, and the “Water” value in “Go To” button 518 may be replaced with an environmental monitoring (or “EM”) value. Any number of other additional or alternative appropriate changes may be made when site screen 500 is switched between environmental monitoring mode and water mode.

Site screen 500 also includes a site type drop down menu 515 that also enables only a particular type of site to be selected. The site type classification designates a group of related sites and may include site types such as, for example, but not limited to, “viable air sample,” “non-viable air sample,” “compressed gas,” “miscellaneous surface,” etc. Different site types may also be created and defined for sites that correspond to environmental monitoring tests as opposed to sites that correspond to water tests. Site types may be created, edited, viewed and removed using a separate site type screen. Such a site type screen will not be described in detail, but it may include a site type listing, corresponding user input fields, and any other additional or alternative displays, fields or information.

Returning to FIG. 5, site screen 500 also includes a site listing 510 that lists each site which is currently defined within the facility and room and having the desired site type selected using drop down menus 405, 406 and 415. As shown in FIG. 5, all site types within room 3554 of “MTP-Building 200” are currently displayed in site listing 510. Additionally, a “New” button 514 is displayed at the bottom of the site listing 510. Touching down on the “New” button 514 enables a new site to be created and defined using the appropriate input fields 512. After the new site has been satisfactorily defined, the new site may be entered into the system by touching down on “Insert” button 516. Any of the currently defined sites may also be edited by selecting the site within the site listing 510. When a site is selected in the site listing 510, the site's corresponding row in site listing 510 will be shown in bold face type. Selecting a site in site listing 510 will cause the current information corresponding to the site to be displayed in user input fields 512, at which point such information may be edited and then resubmitted. Touching down the “X” button displayed at the right end of each row in the site listing 510 enables the corresponding facility to be removed from the site listing 510.

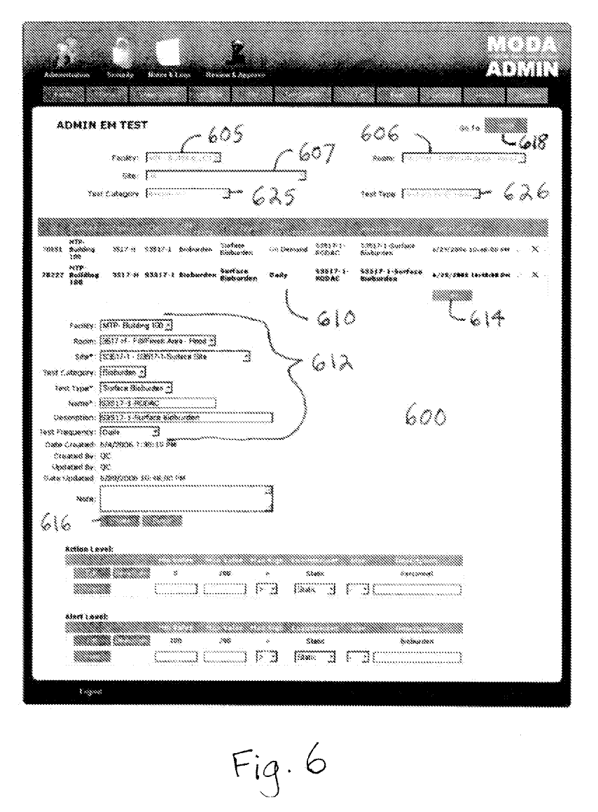

Returning again to FIG. 2, as depicted in node 216, the fourth (leaf) level of the test configuration hierarchy 200 corresponds to tests. An exemplary test screen 600 for creating, editing, viewing and removing tests is shown in FIG. 6. Test screen 600 includes a facility drop down menu 605 that enables a currently defined facility to be selected in which to create, edit, or view tests. Test screen 600 also includes a room drop down menu 606 (which may be replaced with a water system drop down menu in water mode) that further sub-divides the facility selected in the facility drop down menu 605. The rooms that are made available in room drop down menu 506 will depend on the facility that is selected in facility drop down menu 605. Test screen 600 also includes a site drop down menu 607 that further sub-divides the room selected in the room drop down menu 605. The sites that are made available in site drop down menu 607 will depend on the facility and room that are selected in facility and room drop down menus 605 and 606. Like site screen 500 of FIG. 5, test screen 600 also includes a “Go To” button 618 that enables test screen 600 to be switched between environmental monitoring mode and water mode.

Test screen 600 also includes a test category drop down menu 625 that enables only a particular category of test to be selected. The test category classification designates a group of related tests and may include test categories such as, for example, but not limited to, “viable,” “non-viable,” “bioburden,” etc. Different test categories may also be created and defined for environmental monitoring tests as opposed to water tests. Test categories may be created, edited, viewed and removed using a separate test category screen. Such a test category screen will not be described in detail, but it may include a test category listing, corresponding user input fields, and any other additional or alternative displays, fields or information.

Test screen 600 also includes a test type drop down menu 625 that enables only a particular type of test to be selected. The test type classification may be used to sub-divide the test category classification, meaning that each test category may include one or more different test types. The test type classification may include test types such as, for example, but not limited to, “total organic carbon,” “coliform,” “total plate count,” “endotoxin,” “conductivity,” “heavy metals,” “nitrates,” etc. Test types may be created, edited, viewed and removed using a separate test type screen. Such a test type screen will not be described in detail, but it may include a test type listing, corresponding user input fields, and any other additional or alternative displays, fields or information.

Returning to FIG. 6, test screen 600 also includes a test listing 610 that lists each test which is currently defined within the facility, room and site and having the desired test category and test type selected using drop down menus 405, 406, 407, 425 and 426. As shown in FIG. 6, all “surface bioburden” tests within all sites of room 3554 of “MTP-Building 100” are currently displayed in test listing 610. Any of the currently defined tests may be edited by selecting the test within the test listing 610. When a test is selected in the test listing 610, the test's corresponding row in test listing 610 will be shown in bold face type. Selecting a test in test listing 610 will cause the current information corresponding to the test to be displayed in user input fields 612, at which point such information may be edited and then resubmitted by touching down on “Update” button 616. Additionally, a “New” button 614 is displayed at the bottom of the test listing 610. Touching down on the “New” button 614 enables a new test to be created and defined using the appropriate input fields 612. One of the input fields 612 is a “Test Frequency” field which enables the frequency (e.g., hourly, daily, weekly, monthly, quarterly, Monday, Friday, end of shift, on demand, etc.) of the test to be set. Touching down the “X” button displayed at the right end of each row in the test listing 610 enables the corresponding facility to be removed from the test listing 610.

Test screen 600 also includes action level input fields 618 and alert level input fields 620, which enable a level to be set for a corresponding test at which an action or alert notification will be triggered. When test results are entered at a later time, any test results that fall within the defined action or alert ranges will cause a corresponding action or alert notification, such as, for example, an email notification, to be delivered to an appropriate group of subscribers. Thus, the action and alert features provide a fast and efficient notification to appropriate people of events that require prompt attention.

In addition to the facility, room, site and test screens 300, 400, 500 and 600 described in detail above, a number of other screens may be generated and displayed for creating, editing, viewing and removing various information. For example, an equipment screen may be displayed for creating, editing, viewing and removing information corresponding to various test equipment. Additionally, a media screen may be displayed for creating, editing, viewing and removing information corresponding to various media. Furthermore, an organism screen may be displayed for creating, editing, viewing and removing information corresponding to various organisms. As should also be appreciated, any number of additional or alternative screens may be generated and displayed in accordance with the present invention for creating, editing, viewing and removing various information.

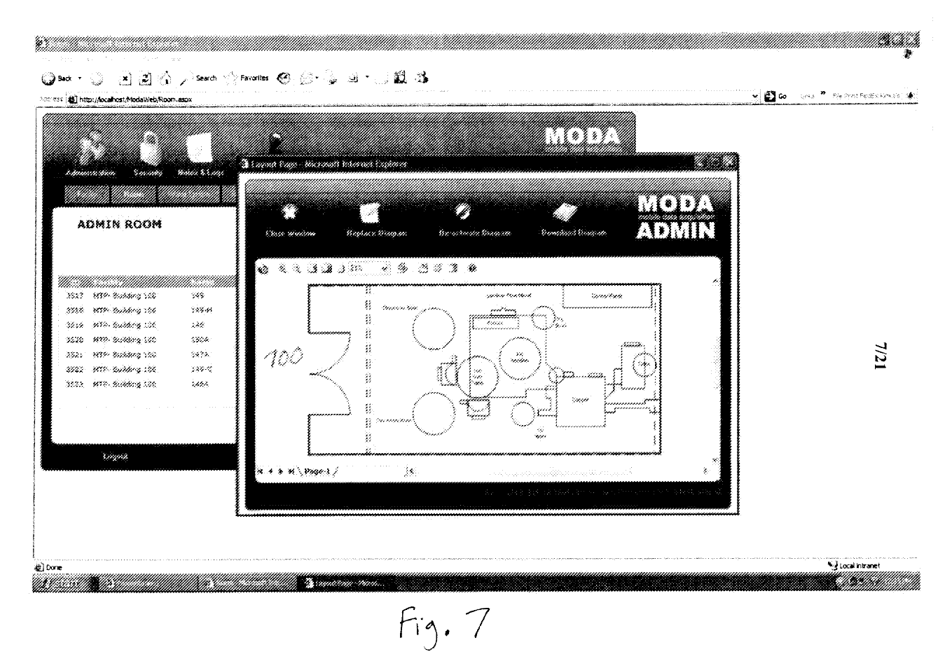

Although not depicted in FIGS. 3-6 above, some or all of the various screens described above and other screens may include links that enable various layouts to be added (e.g., uploaded) or existing layouts to be viewed. A layout is a diagram of an area such as a facility, room or water system that shows various locations and/or entities within the area. For example, a facility layout may show various rooms, water systems, and other locations or entities within the facility. As another example, a room layout may show various sites, equipment, and other locations or entities within the room. An exemplary room layout 700 is shown in FIG. 7.

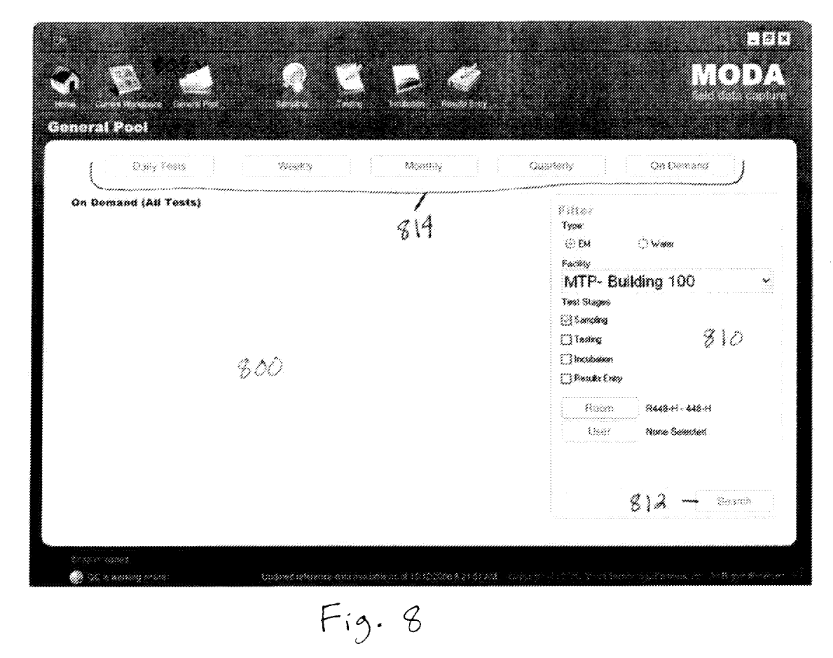

Returning now to FIG. 1, at assign work stage 112, a pool of worked can be viewed, the pool of work can be filtered into different subsets according to various criteria, and subsets of the pool of work can be assigned to individual users. In particular, the pool of work that is defined and scheduled during plan sampling stage 110 may be referred to as the “general pool” of work. The general pool may be viewed and filtered by way of a general pool filter screen. An exemplary general pool filter screen 800 is depicted in FIG. 8. A user may navigate to general pool filter screen 800 by selecting the general pool icon 805. General pool filter screen 800 includes test frequency buttons 814 that enable a particular test frequency (daily, weekly, monthly, quarterly, on demand, and other frequencies if desired) to be selected. General pool filter screen 800 also includes a general pool filter dialog box 810, which includes various input fields for filtering the general pool of work. Specifically, dialog box 810 includes filter type input buttons that enable either environmental monitoring (“EM”) or water tests to be selected. Dialog box 810 also includes a facility drop down menu that enables a particular facility to be selected. Dialog box 810 also includes a set of test stage checkboxes that enable various test stages (e.g., sampling, testing, incubation, and results entry) to be selected. Dialog box 810 also includes room and user input fields that enable particular rooms and users to be selected. The filtering features depicted in filter screen 800 are included by way of example and not limitation, and any number of additional or alternative features may be included in filter screen 800 in accordance with the present invention. After the desired information has been entered into the various input fields of dialog box 810, “Search” button 812 may be clicked to initiate a search of the general pool with the desired filter criteria.

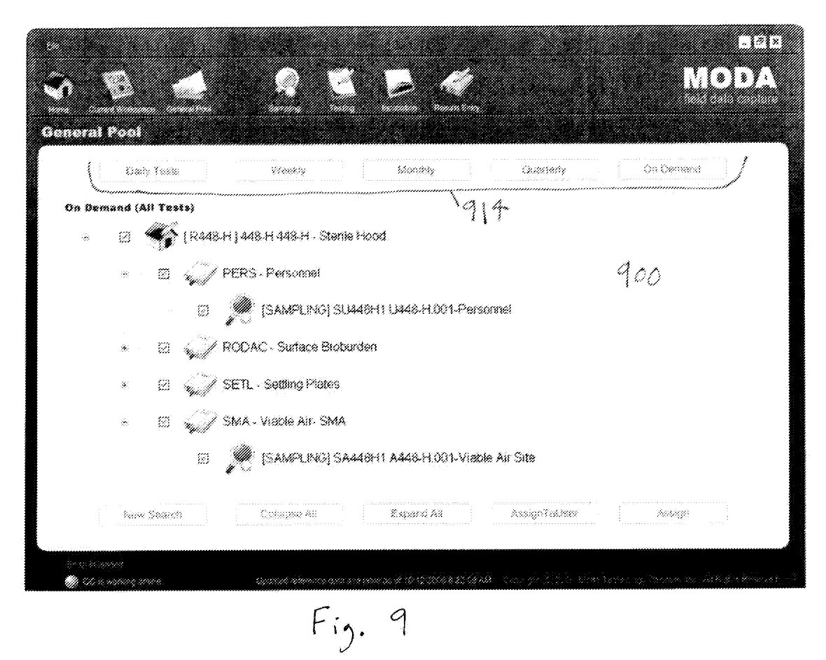

After touching down on “Search” button 812, the results of the search may be displayed using a general pool results screen. An exemplary general pool results screen 900 is depicted in FIG. 9. Results screen 900 displays all tests that match the filter criteria entered into general pool filter dialog box 810 of FIG. 8. Results screen 900 also includes test frequency buttons 914 that enable the results to be re-sorted according to a particular test frequency (daily, weekly, monthly, quarterly, on demand, and other frequencies if desired). Each test listed in results screen 900 may be selected or deselected using its corresponding checkbox. After one or more of the tests in search results screen 900 have been selected, they may be assigned to a user by touching down on “Assign To User” button 910.

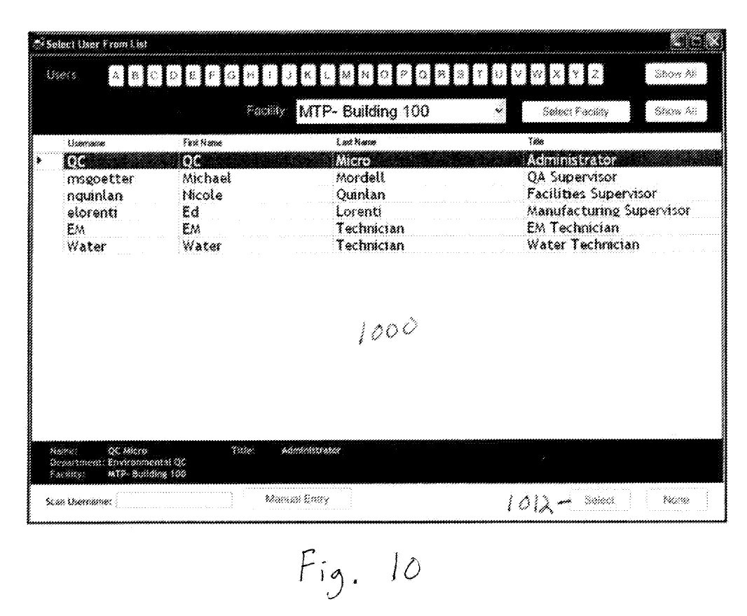

After touching down “Assign To User” button 910, a listing of users may be displayed by way of a user listing screen. An exemplary user listing screen 1000 is depicted in FIG. 10. User listing screen 1000 includes a listing of various attributes of users such as username, first name, last name and title. User listing screen 1000 includes a facility drop down menu that enables the listing of users to be filtered by facility. User listing screen 1000 also includes an alphabetical keypad that enables the listing of users to be filtered alphabetically by username. One of the users in the user listing may be selected by for example, touching down on the row corresponding to the user. After a user has been selected, the tasks selected in general pool results screen 900 of FIG. 9 may be assigned to the user by touching down on “Select” button 1012 in the bottom right hand corner of user listing screen 1000.

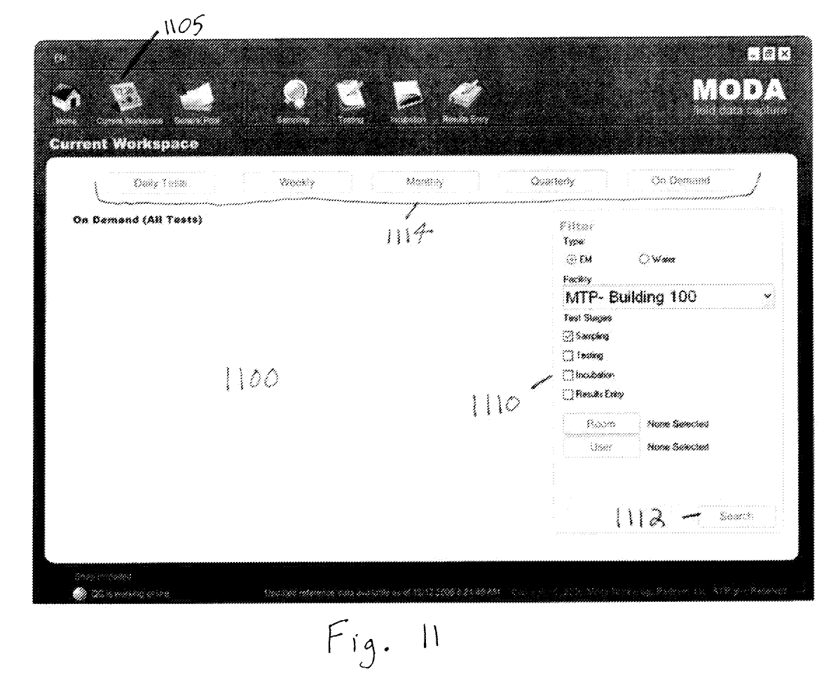

Returning again to FIG. 1, assign work stage 112 is followed by collect samples stage 114. During collect samples stage 114, the subsets of work that are assigned to individual users during assign work stage 112 can be viewed by the individual users. A subset of work that is assigned to a user may be referred to as the user's “current workspace.” A user can view and filter his current workspace by way of a current workspace filter screen. An exemplary current workspace filter screen 1100 is depicted in FIG. 11. A user may navigate to current workspace filter screen 1100 by selecting the current workspace icon 1105. Current workspace filter screen 1100 includes many of the same filtering features that were present in general pool filter screen 800 such as test frequency buttons 1214 and filter dialog box 1110 including a set of filter type input buttons (“EM” and “Water”), a facility drop down menu, a set of test stage checkboxes (“Sampling,” “Testing,” “Incubation” and “Results Entry”), room and user input fields, and “Search” button 1112. As should be appreciated, however, current workspace filter screen 1100 need not necessarily include the same filtering features that are present in general pool filter screen 800. Any number of additional or alternative filtering features may be included in either current workspace filter screen 1100 or general pool filter screen 800 in accordance with the present invention.

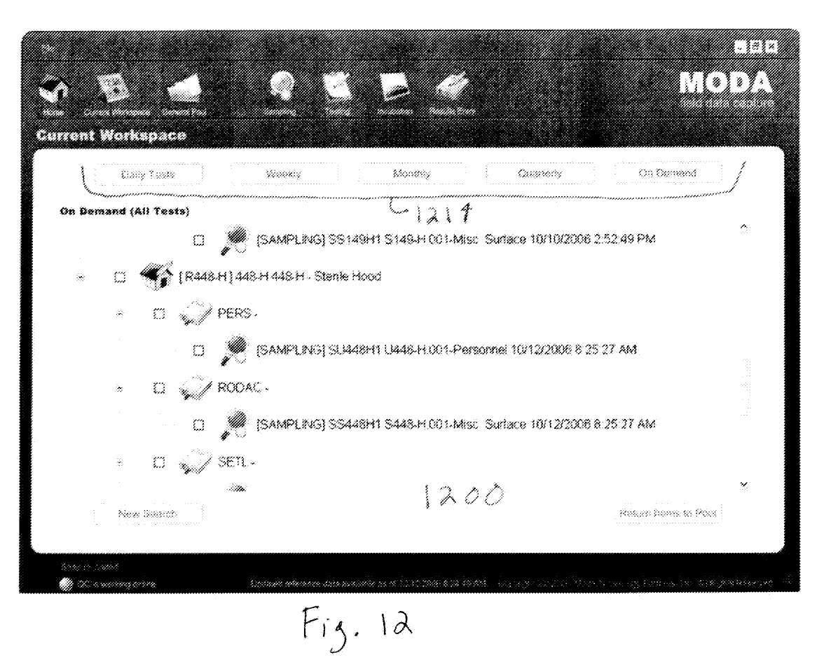

After touching down on “Search” button 1112, the results of the search may be displayed using a current workspace results screen. An exemplary current workspace results screen 1200 is depicted in FIG. 12. Results screen 1200 displays all tests that match the filter criteria entered into current workspace filter dialog box 1110 of FIG. 11. Results screen 1200 also includes test frequency buttons 1214 that enable the results to be re-sorted according to a particular test frequency (daily, weekly, monthly, quarterly, on demand, and other frequencies if desired).

Once a user is aware of his current workspace, the user may then being to collect individual samples for tests in his workspace. To enable efficient collection and eventual processing of samples, various locations and entities within a facility, including the users themselves, may each have an associated barcode. For example, each room, water system, site, equipment, media, sample, user, or any other locations or entities within a facility may have an associated barcode. Each user may, for example, have his associated barcode displayed on an identification card or tag or any other appropriate area. Additionally, each room may, for example, have a barcode that is displayed on a wall at the entrance to the room or any other appropriate area. Use of these barcodes at different stages of the testing process will be described in detail below.

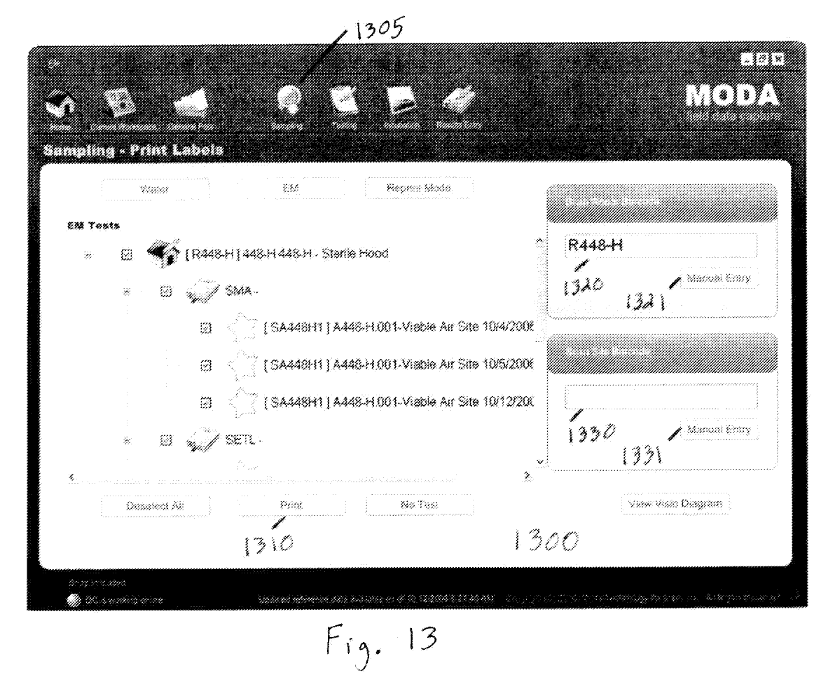

In combination with the barcodes, to enable efficient collection and eventual processing of samples, one or more labels may also be generated for each sample or group of samples. These labels may be generated using a sampling screen. An exemplary sampling screen 1300 is depicted in FIG. 13. A user may navigate to sampling screen 1300 by selecting the sampling icon 1305. Sampling screen 1300 includes a room input field 1320. A room may be entered into the room input field 1320 by, for example, scanning the room's associated barcode with an attached barcode scanning device. A room may also be entered into the room input field 1320 by, for example, touching down on manual entry button 1321 and then typing in the room number or name. Sampling screen 1300 also includes a site input field 1330. A site may be entered into the site input field 1320 by, for example, scanning the site's associated barcode or touching down on manual entry button 1331 and the typing in the site identification or name. After a room and/or site has been entered into room input field 1320 and/or site input field 1330, the corresponding tests within the room and/or site will be displayed in sampling screen 1300. Each test listed in sampling screen 1300 may be selected or deselected using its corresponding checkbox. After one or more of the tests in sample screen 1300 have been selected, labels may generated for the selected tests by touching down on “Print” button 1310.

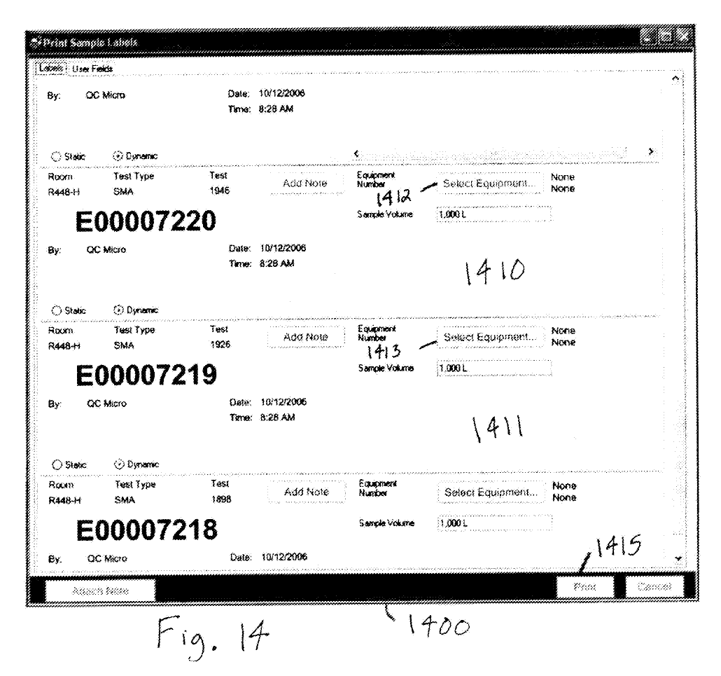

After touching down on “Print” button 1310, labels for each of the selected tests may be generated and displayed on a print label screen. An exemplary print label screen 1400 is depicted in FIG. 14. Print label screen 1400 includes exemplary labels 1410 and 1411. Each label 1410 and 1411 includes a unique sample number (E00007220 and E00007219) and indicates the room, test type, test, date, time, user performing the test, volume, and equipment used to perform the test. The equipment used to perform the test may be selected using “Select Equipment” buttons 1412 and 1413. As should be appreciated, the information shown in each of labels 1410 and 1411 is included by way of example and not limitation. Any appropriate additional or alternative information may be included in labels 1410 and 1411 in accordance with the present invention. Once all the desired and necessary information has been entered into labels 1410 and 1411, the labels may be printed by touching down in “Print” button 1415. Once a label has been printed for a corresponding sample, the user can proceed to collect the sample.

Various tools may be employed to assist users while collecting and processing samples or during any other stage of the testing process. For example, a standard operation procedure (SOP) or any other relevant procedures or regulations for a corresponding location, product, company, laboratory, group of tests, or any other entity or organization may be uploaded, stored, and made accessible to authorized users at any appropriate time. Additionally, room and facility layouts, or any other relevant diagrams, may also be uploaded, stored, and made accessible to authorized users at any appropriate time. For example, a room layout may be accessed by a user upon entering the corresponding room, and the room layout may be employed to lead the user around the room by showing the user locations of various test sites and optionally a suggested sequence for navigating through the various test sites.

As part of collecting and/or processing samples, one or more testing processes may need to be performed on the samples such as, for example, dilution or incubation. A number of screens, labels and/or other features may be generated or displayed to assist with such testing processes. For example, for tests that require dilution, a testing screen may be generated and displayed that may enable data regarding samples, locations, volumes, equipment, and other information to be entered and recorded and corresponding labels to be generated. Equipment information may, for example, be entered into an input field by scanning a barcode on the corresponding piece of equipment. As another example, for tests that require incubation, an incubation screen may be generated and displayed that may enable data regarding samples, locations, equipment (e.g., incubators) and other information to be entered and recorded and the incubation process to be initiated.

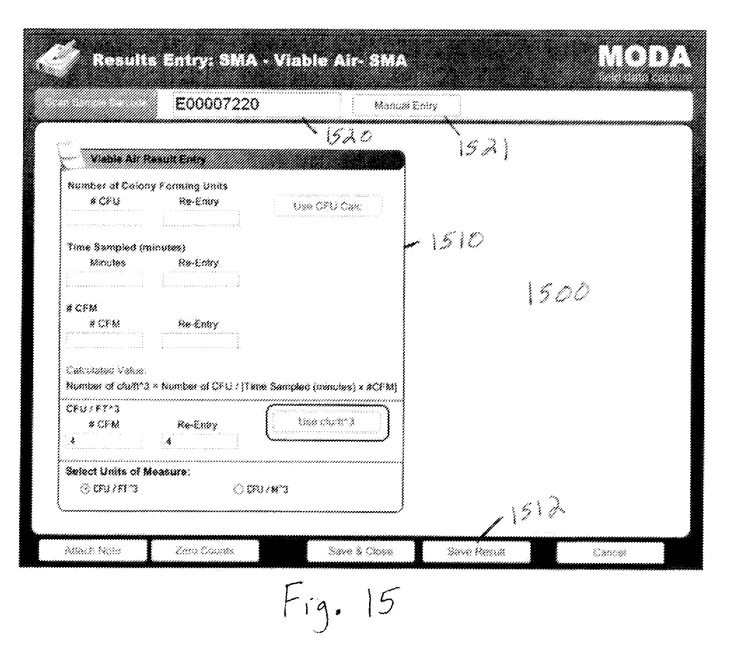

After samples have been collected and processed, the results of the testing may entered by way of a results entry screen. An exemplary results entry screen 1500 is depicted in FIG. 15. Results entry screen 1500 includes a results entry dialog box 1510 including a number of input fields in which the test results and other related information may be entered. The particular input fields that are displayed in dialog box 1510 may vary depending upon factors such as test category, test type, test, and any number of additional or alternative factors. The input fields shown in dialog box 1510 are exemplary input fields for a viable air entry test. A different set of input fields may, for example, be provided for a conductivity, endotoxin, or heavy metals test. Once the necessary information has been entered into dialog box 1510, the information may be recorded and save by touching down on “Save Result” button 1512. If any of the entered test results fall within the defined action or alert ranges, an action or alert notification may be promptly generated and delivered to an appropriate group of recipients. To enter results for another sample, the sample number may be entered into sample input field 1520 by, for example, scanning the barcode associated with the sample or touching down on “Manual Entry” button 1521 and typing in the sample number.

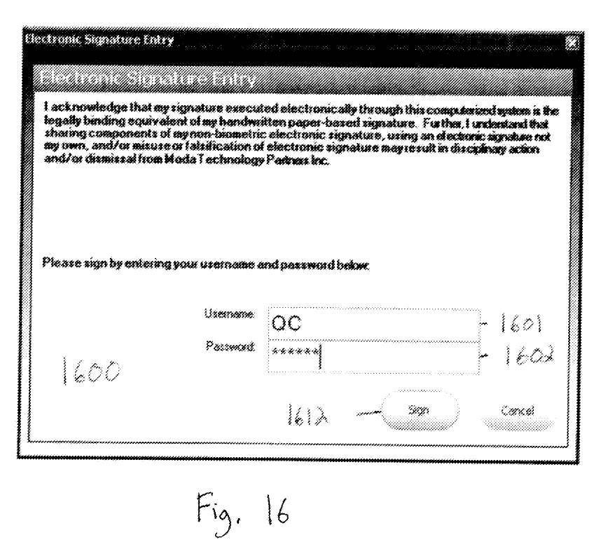

After the results have been entered, the results may be viewed and approved by a user. The user that approves the results may be the same or different from the user that entered the results. Entered results may be searched, filtered, and viewed using any appropriate criteria such as for example, by facility, room, water system, site, site type, test, test frequency, test type, test category, date, user, equipment, media, organism, product, batch, lot, or any other appropriate criteria. Once a desired subset of entered results is located, the entered results may be approved by a user by way of an electronic signature. The entered results may be approved of on a one-by-one basis or, alternatively, multiple “gang” results may be approved of using a single signature. An exemplary electronic signature screen 1600 is depicted in FIG. 16. Electronic signature screen 1600 includes username and password input fields 1601 and 1602 that enable the user to identify himself. As should be appreciated, any additional or alternative information may be entered into electronic signature screen 1600 to identify the user or provide other information. After the user has identified himself, the user can complete the electronic signature by touching down on “Sign” button 1612. An electronic signature may additionally or alternatively be required during one or more other steps in the testing process such as for example, during scheduling, collection of samples, and/or viewing and analyzing results.

Returning again to FIG. 1, the final stage of environmental monitoring workflow 100 is analyze results stage 120. During analyze results stage 120, results may be filtered according to various criteria and viewed, explored and analyzed using various analysis tools. In particular, during analyze results stage 120, approved results may once again be searched, filtered, and viewed using any appropriate criteria such as for example, by facility, room, water system, site, site type, test, test frequency, test type, test category, date, user, equipment, media, organism, product, batch, lot, or any other appropriate criteria. Additionally, results may also be filtered according to values of the results themselves, such as whether they are equal, above, below or within range of a particular value or whether they fall within the defined action and/or alert ranges. Once a desired subset of results is located, the results may be viewed, explored, and analyzed using various analysis tools including, for example, but not limited to, tables, graphs, charts, layouts, spreadsheets and/or reports. Such analysis tools may, for example, enable problems with a particular location, product, user, equipment, media, organism, or any other location or entity to be easily, quickly and efficiently identified and resolved.

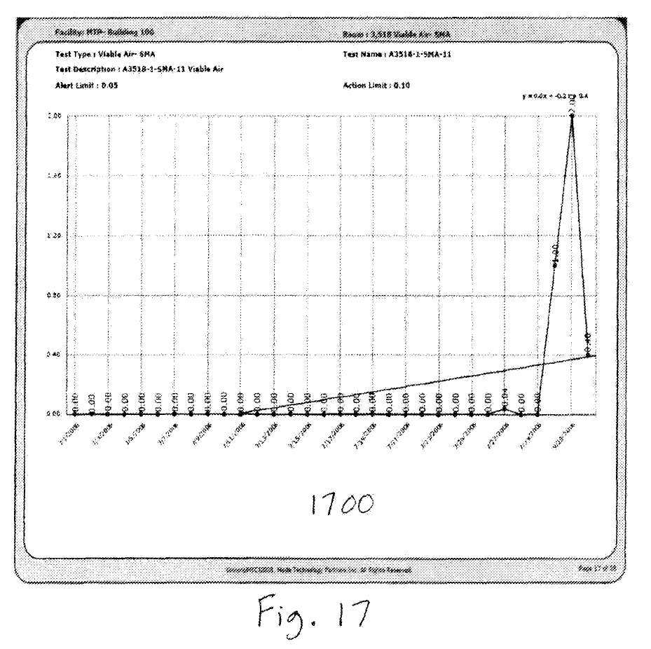

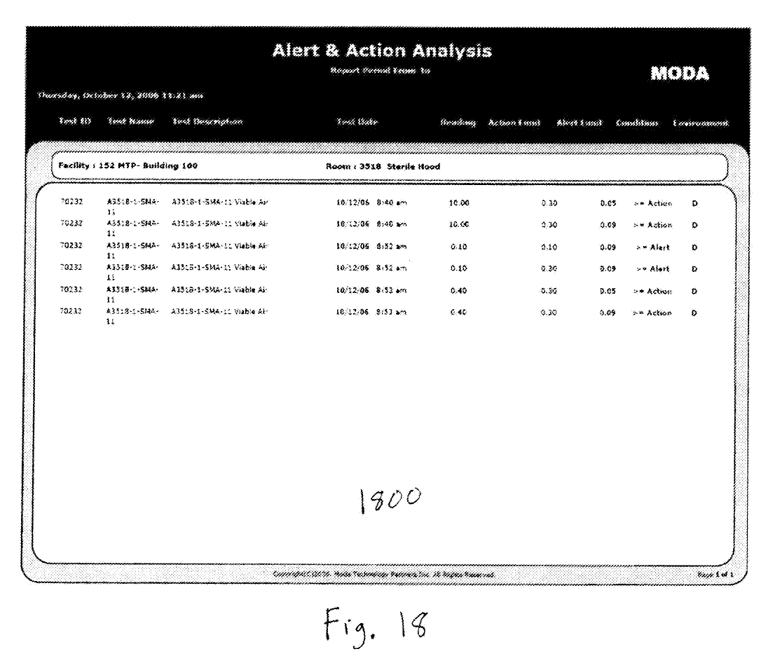

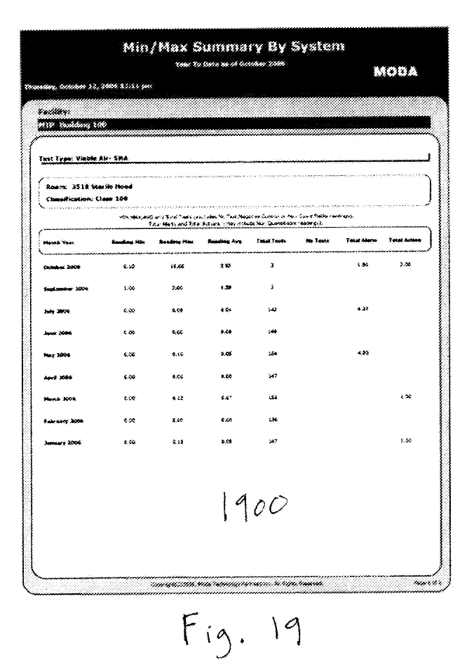

A number of exemplary analysis tools are depicted in FIGS. 17-19. Specifically, an exemplary test result graph 1700 is depicted in FIG. 17. Test result graph 1700 is a graph that shows results for test “A3518-1-SMA-11” over a specified time period in graphical form. Additionally, an exemplary action and alert chart 1800 is depicted in FIG. 18. Action and alert chart 1800 shows all action and alerts that resulted from tests performed in room 3518 of 152 MTP-Building 100 over a specified time period. Furthermore, an exemplary minimum and maximum value chart 1900 is depicted in FIG. 19. Minimum and maximum value chart 1900 shows the monthly minimum value, maximum value, average value, total number of test, total number of non-tests, and total alerts and actions for minimum and maximum value chart 1900 from January-October 2006. The graphs and charts shown in FIGS. 17-19 are provided by way of example and not limitation, and any number of graphical, chart or other formats may be used to display test results filtered according to any appropriate criteria in accordance with the present invention. In addition to graphs and charts, a wide variety of other analysis tools may be employed. For example, all or a desired subset of results may be exported into an excel spreadsheet. As another example, test results such as actions and alerts may be superimposed at their corresponding sites in a room layout. The actions and alerts may, for example, be displayed with various effects (e.g., different color fonts, different sizes, flashing text) to indicate their importance and draw attention from the user.

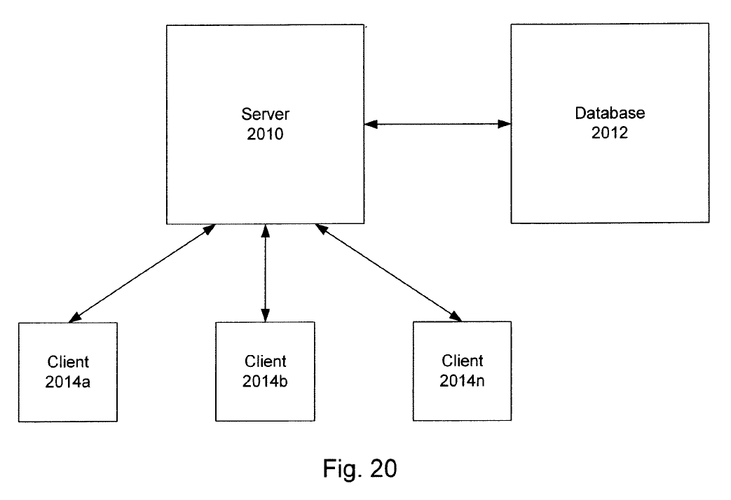

An exemplary environmental monitoring (“EM”) system 2000 in accordance with the present invention is shown in FIG. 20. EM system 2000 includes server 2010, database 2012, and clients 2014a-n. As should be appreciated, any number of servers, databases and clients may be used in accordance with the present invention. Server 2010, database 2012, and clients 2014a-n may communicate with one another using one or more suitable wired or wireless networks including, but not limited to, a local area network (LAN) or a wide area network (WAN) such as the Internet. Additionally, server 2010, database 2012, and clients 2014a-n may be connected to and/or integrated with any number of other systems and/or networks via any suitable network connections. Server 2010, database 2012, and clients 2014a-n may include any combination of one or more wired or wireless computing devices such as desktop computers, laptop computers and mobile or hand held devices.

Any or all of the features described above in FIGS. 3-19 and any other associated features may be available via any combination of one or more application programs and/or software packages executing on server 2010, clients 2014a-n, and possibly other devices. For example, in one embodiment, a server software package may execute in combination with a client software package and also an analysis tools software package. Each of these software packages may enable insertion, viewing, updating, filtering, and/or removal of data that is stored in database 2012 and/or other devices. Thus, the server, client and analysis tools data packages may combine to form an integrated system that offers fast, efficient and convenient access to and manipulation of underlying data with minimal, if any, need for transfer or repeated entry of data. As should be appreciated, various security features such as defined access permission levels, passwords, barcodes, and any other appropriate features may be employed to ensure that the data handled by server 2010, database 2012, and clients 2014a-n or any other devices is made available only to authorized users.

Some or all of clients 2014a-n may be portable field data capture (“FDC”) devices that are transported to various test sites. Accordingly, it may be desirable for the FDC devices to communicate with other devices in system 2000, such as server 2010, using a wireless network connection. Additionally, these devices may include “severability” functionality that allows sampling technicians to continue working through disruptions in network connectivity. The FDC clients may be capable of storing information that is entered into the FDC clients during the interruptions. Once connectivity is restored, the clients and servers may automatically or upon command synchronize the appropriate information.

Because the FDC devices may be transported into environments which are to be kept as sterile as possible, it may also be desirable for these devices to be designed to reduce contamination of the environments in which they operate. For example, the FDC devices may operate without a fan and may include thermal printers to reduce dust and particle spreading. The FDC computers may be bundled with various peripherals that may assist throughout the testing process such as, for example, a barcode reader, barcode printer, badge reader, and a stainless steel cart that can be used to transport the FDC computers, their attached peripherals, and various sampling media and testing equipment. The entire FDC configuration may be constructed such that it can be sanitized using standard chemical disinfectants without harming the computer or its peripherals. Accordingly, it may be desirable for the FDC devices to include touch screen data input devices which are sensitive to a user touching down on various portions of the screen. The above discussion of FIGS. 3-16 refers to “touching down” on various portions of screens, such as may be done by a user via a touch screen input device. As should be appreciated, however, the present invention is not limited to touch screen input devices, and any other additional or alternative input devices may be employed.

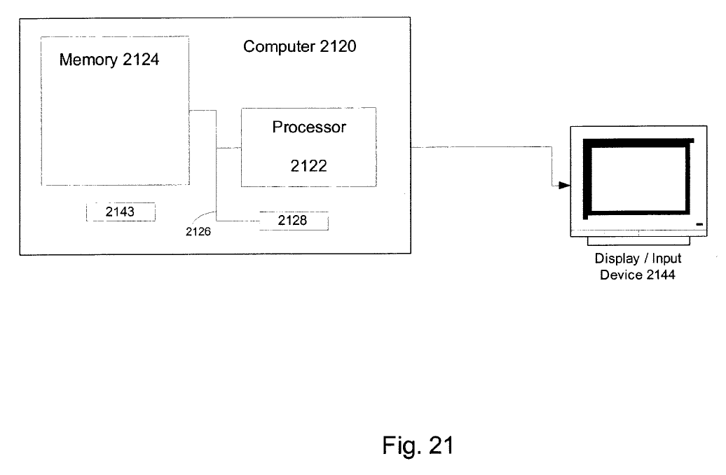

Server 2010, database 21012 and clients 2014a-n may comprise an appropriately programmed computing device. FIG. 21 is a block diagram of a generic computing system suitable for use in a system in accordance with the present invention. As shown, computing device 2120 includes processing unit 2122, system memory 2124, and system bus 2126 that couples various system components including system memory 2124 to the processing unit 2122. The system memory 2124 might include read-only memory (ROM) and random access memory (RAM). The system might further include hard-drive 2128, which provides storage for computer readable instructions, data structures, program modules and other data. As mentioned above, display/input device 2144 may comprise a touch sensitive display screen. Alternatively, device 2144 may be a monitor and separate input device such as an attached mouse and keyboard may be employed. Communications device 2143, which in one embodiment may be a modem, provides for communications over a network. Processor 2122 can be programmed with instructions to perform various processes such as those described above. The instructions may be received from over a network or stored in memory 2124 and/or hard drive 2128. Processor 2122 may be loaded with any one of several computer operating systems such as Windows XP, Windows Vista, or Linux.

Those skilled in the art understand that computer readable instructions for implementing the above described processes can be generated and stored on one of a plurality of computer readable media such as a magnetic disk or CD-ROM. Further, a computer such as that described with reference to FIG. 21 may be arranged with other similarly equipped computers in a network and loaded with computer readable instructions for performing the above described processes. Specifically, referring to FIG. 21, microprocessor 2122 may be programmed to operate in accordance with the above-described processes.

While the invention has been described and illustrated with reference to specific embodiments, those skilled in the art will recognize that modification and variations may be made without departing from the principles of the invention as described above and set forth in the following claims. For example, while the invention has been described in connection with a test configuration hierarchy having four levels, a test configuration hierarchy in accordance with the present invention may include any number of different levels. Accordingly, reference should be made to the appended claims as indicating the scope of the invention.

What is claimed:

1. A method for monitoring an environment according to a test configuration hierarchy, the method comprising:
providing the test configuration hierarchy comprising a leaf level and a root level, the leaf level of the hierarchy corresponding to a test, the root level of the hierarchy corresponding to a location at which a sample is collected in accordance with the test;
receiving an instance of the test configuration hierarchy, the leaf level of the instance identifying a particular test, the root level of the instance identifying a particular location at which at which a sample is collected in accordance with the particular test;
receiving a test assignment command that assigns the particular test to at least one individual;
receiving a test result entry that specifies at least one result value resulting from performance of the test; and
storing the instance of test configuration hierarchy, the test assignment command, and the test result entry such that the at least one result value is associated with the at least one individual, the particular test and the particular location.

2. The method of claim 1, wherein the leaf level of the hierarchy corresponds to a testing facility.

3. The method of claim 2, wherein the hierarchy further comprises a second level that is a direct child of the root level.

4. The method of claim 3, wherein the second level corresponds to a room within the facility.

5. The method of claim 3, wherein the second level corresponds to a water system within the facility.

6. The method of claim 3, wherein the hierarchy further comprises a third level that is a direct child of the second level, the third level corresponding to a test site.
